(19) United States
(12) Patent Application Publication
(10) Pub. No.: US 2020/0250645 A1
(43) Pub. Date: Aug. 6, 2020

(54) ORDER SYSTEM, ORDER MANAGEMENT APPARATUS, AND INFORMATION PROCESSING PROGRAM

(71) Applicant: TOSHIBA TEC KABUSHIKI KAISHA, Tokyo (JP)

(72) Inventors: Yoshinori ANZAI, Katsushika Tokyo (JP); Yu SAITO, Fujisawa Kanagawa (JP); Tetsuhiko KIMOTSUKI, Kawasaki Kanagawa (JP); Kentaro HIRAYAMA, Yokohama Kanagawa (JP); Ryu MORITA, Ota Tokyo (JP)

(73) Assignee: TOSHIBA TEC KABUSHIKI KAISHA, Tokyo (JP)

(21) Appl. No.: 16/689,997

(22) Filed: Nov. 20, 2019

(30) Foreign Application Priority Data
Feb. 1, 2019 (JP) 2019-017141

(51) Int. Cl. G06Q 20/20; G06Q 20/10

(52) U.S. Cl. CPC G06Q 20/202; G06K 19/06037; G06Q 20/102; G06Q 20/209

(57) ABSTRACT

An order system according to an embodiment includes accepting sections, an order managing section, an operating section, a determining section, and a settlement managing section. Each accepting section accepts an order. The order managing section manages an order accepted by a first accepting section of the accepting sections in association with a first order terminal. The operating section causes an information terminal carried by a customer to acquire settlement data for settling, with a network settlement service, the order managed by the order managing section. The determining section determines completion of the settlement by the network settlement service based on the settlement data. The settlement managing section manages, based on a result of the determination in the determining section, whether settlement concerning each of the plurality of order terminals is completed.

### CROSS-REFERENCE TO RELATED APPLICATION

This application is based upon and claims the benefit of priority from Japanese Patent Application No. 2019-017141, filed on Feb. 1, 2019, the entire contents of which are incorporated herein by reference.

### FIELD

Embodiments described herein relate generally to an order system, an order management apparatus, and an information processing program.

### BACKGROUND

It has been known to enable a customer to perform settlement of a price (e.g., a check out or order completion process) while the customer is seated in a restaurant. However, if the customer can perform the settlement of the price while at the customer's seat without intervention of a store clerk, it is difficult for the store clerk to accurately recognize which customers among a plurality of customers present in the restaurant have already finished settlement and which customers have not finished settlement. Under such circumstances, it has been demanded to enable a store clerk to easily recognize a situation of settlement concerning a plurality of customers while enabling a customer to perform settlement without the intervention of the store clerk.

Related art is described in, for example, JP-A-2018-151757.

### DESCRIPTION OF THE DRAWINGS

FIG. 1 is a diagram illustrating a schematic configuration of a POS system according to a first embodiment;

FIG. 2 is a block diagram illustrating a main part circuit configuration of a table terminal illustrated in FIG. 1;

FIG. 3 is a block diagram illustrating a main part circuit configuration of an order management apparatus illustrated in FIG. 1;

FIG. 4 is a block diagram illustrating a main part circuit configuration of a POS terminal illustrated in FIG. 1;

FIG. 5 is a flowchart of table terminal processing by a processor illustrated in FIG. 2;

FIG. 6 is a flowchart of management processing by a processor illustrated in FIG. 3;

FIG. 7 is a flowchart of the management processing by the processor illustrated in FIG. 3;

FIG. 8 is a diagram illustrating a selection screen;

FIG. 9 is a diagram illustrating a first guidance screen;

FIG. 10 is a diagram illustrating a second guidance screen;

FIG. 11 is a diagram illustrating a third guidance screen;

FIG. 12 is a flowchart of checkout processing by a processor illustrated in FIG. 4;

FIG. 13 is a diagram illustrating an instruction screen;

FIG. 14 is a diagram illustrating a finish screen;

FIG. 15 is a diagram illustrating a schematic configuration of a POS system according to a second embodiment;

FIG. 16 is a block diagram illustrating a main part circuit configuration of a table terminal illustrated in FIG. 15;

FIG. 17 is a block diagram illustrating a main part circuit configuration of an order management apparatus illustrated in FIG. 15;

FIG. 18 is a flowchart of table terminal processing by a processor illustrated in FIG. 16;

FIG. 19 is a diagram illustrating a completion screen; and

FIG. 20 is a flowchart of management processing by a processor illustrated in FIG. 17.

### DETAILED DESCRIPTION

An object of embodiments described herein is to provide an order system, an order management apparatus, and an information processing program that enable a store clerk to easily recognize a situation of settlement concerning a plurality of customers while enabling a customer to perform settlement without intervention of the store clerk.

According to an embodiment, there is provided an order system including a plurality of order terminals and an order management apparatus, the order system including: an accepting section provided in each of the plurality of order terminals; an order managing section provided in the order management apparatus; an operating section provided in at least one of the order terminal and the order management apparatus; a determining section provided in the order terminal or the order management apparatus; and a settlement managing section provided in the order management apparatus. The accepting section accepts an order. The order managing section manages the order accepted by the accepting section in association with the order terminal in which the accepting section that accepts the order is provided. The operating section performs operation for causing an information terminal carried by a customer to acquire settlement data for settling, with a network settlement service, the order managed by the order managing section. The determining section determines completion of the settlement by the network settlement service based on the settlement data. The settlement managing section manages, based on a result of the determination in the determining section, whether settlement concerning each of the plurality of order terminals is completed.

Several embodiments are explained below with reference to the drawings. In the embodiments, a point-of-sale (POS) system including an order system for order management is explained as an example.

### First Embodiment

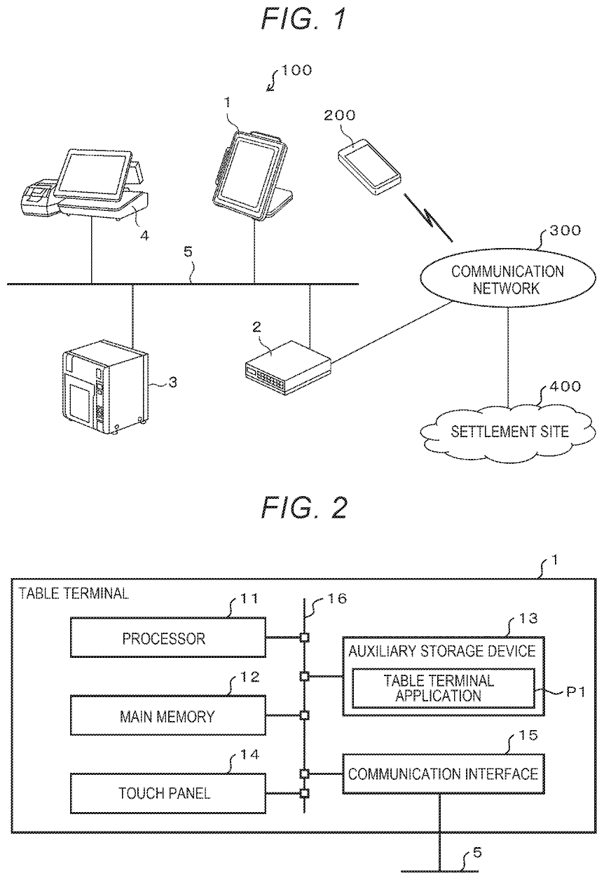

FIG. 1 is a diagram illustrating a schematic configuration of a POS system 100 according to a first embodiment. The POS system 100 is usable in various facilities such as a restaurant that perform services for providing commodities such as foods and beverages according to orders of customers.

The POS system 100 includes a table terminal 1, an order management apparatus 2, a slip printer 3, a POS terminal 4, and a communication network 5. One table terminal 1, one order management apparatus 2, one slip printer 3, and one POS terminal 4 are illustrated in FIG. 1. However, a plurality of table terminals 1 are included in the POS system 100. A plurality of order management apparatuses 2, a plurality of slip printers 3, and a plurality of POS terminals 4 may be included in the POS system 100. The POS system 100 is configured to enable the table terminal 1, the order management apparatus 2, the slip printer 3, and the POS terminal 4 to communicate with one another via the communication network 5.

The table terminal 1 is set in a customer attendance floor and operated by a customer. The table terminal 1 is called self-order terminal as well and is an example of an order terminal. The table terminal 1 is placed on, for example, a table used by a customer for eating and drinking and is used for a series of orders by one customer or a group of customers who uses the table. The table terminal 1 executes operation for causing an information terminal 200 carried by a customer to acquire settlement data. The operation and the settlement data are explained in detail below. The order management apparatus 2 manages an order accepted by the table terminal 1. The order management apparatus 2 manages a settlement situation of a price of an order in each table terminal 1. The order management apparatus 2 is capable of communicating with a settlement site 400 via a communication network 300.

The slip printer 3 is set in, for example, the customer attendance floor or a kitchen. The slip printer 3 set in the customer attendance floor prints an order slip for a customer. That is, the slip printer 3 set in the customer attendance floor is a so-called customer printer. The slip printer 3 set in the kitchen prints a cooking slip for a cook. That is, the slip printer 3 set in the kitchen is a so-called kitchen printer. The POS terminal 4 is set in, for example, a checkout counter. The POS terminal 4 performs information processing concerning various jobs for sales management including at least accounting of a price concerning an order.

The communication network 5 transmits data mutually exchanged by apparatuses having a communication function such as the table terminal 1, the order management apparatus 2, the slip printer 3, and the POS terminal 4. As the communication network 5, typically, a local area network (LAN) is used. However, as the communication network 5, besides the LAN, various communication networks such as the Internet, a virtual private network (VPN), a public communication network, and a mobile communication network can be used independently or used in combination as appropriate.

The information terminal 200 is an information processing apparatus carried by a customer. The information terminal 200 is typically a smartphone. However, as the information terminal 200, various information processing apparatuses operable by the customer around the table terminal 1 such as a tablet terminal and a notebook personal computer can be used. The information terminal 200 may be a dedicated information processing apparatus for information processing for online settlement explained below.

The communication network 300 is typically the Internet. However, as the communication network 300, besides the Internet, various communication networks such as a LAN, a VPN, a public communication network, and a mobile communication network are sometimes used independently or used in combination as appropriate. The communication network 5 and the communication network 300 may be the same network.

The settlement site 400 executes information processing for settlement responding to a request from the information terminal 200 received via the communication network 300. That is, the settlement site 400 provides a network settlement service. The settlement site 400 may be realized by a single server or a plurality of servers or may be realized on a cloud. As the settlement site 400, for example, an existing site provided by an online settlement agent can be used. The settlement site 400 includes, for example, a server that executes information processing for settlement. The server is an example of a settlement apparatus. The network settlement service provided by the settlement site 400 may be usable in the POS terminal 4. In this case, the POS terminal 4 is capable of accessing the settlement site 400 via the communication network 300.

FIG. 2 is a block diagram illustrating a main part circuit configuration of the table terminal 1. The table terminal 1 includes a processor 11, a main memory 12, an auxiliary storage device 13, a touch panel 14, a communication interface 15, and a transmission line 16.

The processor 11, the main memory 12, and the auxiliary storage device 13 are connected by the transmission line 16 to configure a computer that executes information processing for realizing functions of the table terminal 1. The processor 11 is a central part of the computer. The processor 11 executes information processing based on information processing programs such as an operating system, middleware, and application programs stored in the main memory 12 and the auxiliary storage device 13.

The main memory 12 is equivalent to a main storage portion of the computer. The main memory 12 includes a nonvolatile memory region and a volatile memory region. The main memory 12 stores, in the nonvolatile memory region, at least a part of the information processing programs.

The main memory 12 sometimes stores, in the nonvolatile or volatile memory region, data necessary for the processor 11 in executing processing for controlling the sections. The main memory 12 uses the volatile memory region as a work area in which data is rewritten as appropriate by the processor 11.

The auxiliary storage device 13 is equivalent to an auxiliary storage portion of the computer. The auxiliary storage device 13 is, for example, an electric erasable programmable read-only memory (EEPROM), a hard disc drive (HDD), or a solid state drive (SSD). The auxiliary storage device 13 saves data used by the processor 11 in performing various kinds of processing or data generated by the processing in the processor 11. The auxiliary storage device 13 sometimes stores a part of the information processing programs. In this embodiment, the auxiliary storage device 13 stores a table terminal application P1 serving as one of the information processing programs. The table terminal application P1 is an application program for realizing various functions of the table terminal 1.

The touch panel 14 includes an input device and a display device. The touch panel 14 inputs operation by a customer using the input device. The touch panel 14 displays, using the display device, various screens for notifying various kinds of information to the customer. The communication interface 15 performs data communication via the communication network 5. As the communication interface 15, for example, a well-known communication device for data communication via a LAN can be applied. The transmission line 16 includes an address bus, a data bus, and a control signal line and transmits data and control signals exchanged among the sections connected to the transmission line 16.

As basic hardware of the table terminal 1, for example, a tablet computer apparatus can be used. In this case, transfer of the table terminal 1 is typically performed in a state in which the table terminal application P1 is stored in the auxiliary storage device 13. However, the computer apparatus in which the table terminal application P1 is not stored in the auxiliary storage device 13 or an information processing program of another version of the same type is stored in the main memory 12 or the auxiliary storage device 13 and the table terminal application P1 may be separately transferred. The table terminal application P1 may be written in the auxiliary storage device 13 included in the computer apparatus according to operation of any operator to configure the table terminal 1. In this case, the transfer of the information processing program can be performed by recording the information processing program in a removable recording medium such as a magnetic disk, a magneto-optical disk, an optical disk, or a semiconductor memory or can be performed by communication via a network. In any case, the table terminal application P1 may be stored in the main memory 12.

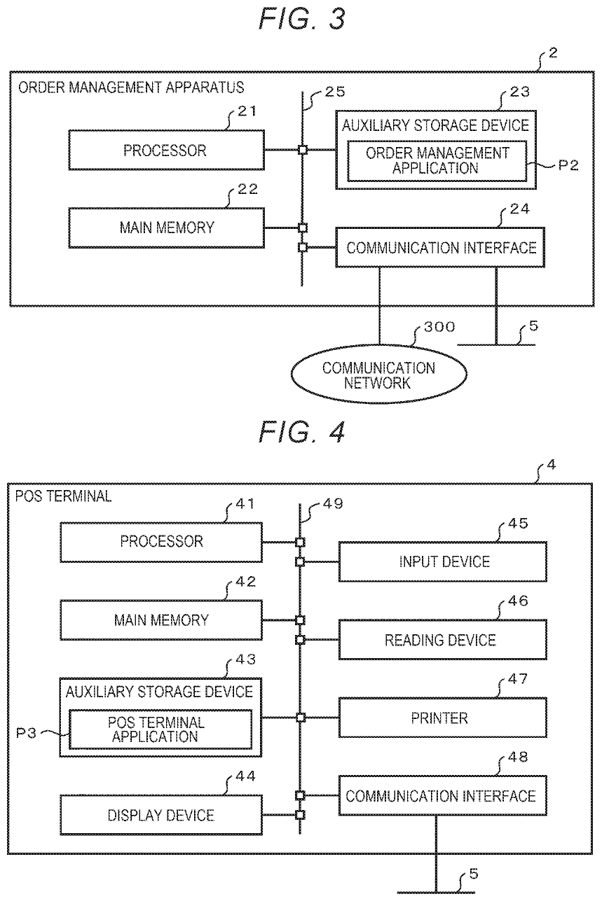

FIG. 3 is a block diagram illustrating a main part circuit configuration of the order management apparatus 2. The order management apparatus 2 includes a processor 21, a main memory 22, an auxiliary storage device 23, a communication interface 24, and a transmission line 25.

The processor 21, the main memory 22, and the auxiliary storage device 23 have the same functions as the functions of the processor 11, the main memory 12, and the auxiliary storage device 13. The processor 21, the main memory 22, and the auxiliary storage device 23 are connected by the transmission line 25 to configure a computer that performs information processing for realizing various functions of the order management apparatus 2. However, the auxiliary storage device 23 stores an order management application P2 instead of the table terminal application P1. The order management application P2 is an application program for realizing various functions for order management.

The communication interface 24 performs data communication via the communication network 5 and the communication network 300. As the communication interface 24, for example, a well-known communication device for data communication via a LAN or data communication via the Internet can be applied. The transmission line 25 includes an address bus, a data bus, and a control signal line and transmits data and control signals exchanged among the sections connected to the transmission line 25.

As basic hardware of the order management apparatus 2, for example, a general-purpose computer apparatus can be used. In this case, typically, the computer apparatus in which the order management application P2 is not stored in the auxiliary storage device 23 and the order management application P2 are separately transferred to a company or the like that operates a store. The transfer of the order management application P2 can be realized by recording the order management application P2 in a removable recording medium such as a magnetic disk, a magneto-optical disk, an optical disk, or a semiconductor memory or realized by downloading the order management application P2 via a network. In this case, the order management application P2 is written in the auxiliary storage device 23 according to operation by an administrator or a serviceperson of the order management apparatus 2. However, the order management apparatus 2 configured by storing the order management application P2 in the main memory 22 or the auxiliary storage device 23 of the computer apparatus may be transferred to the company or the like. In any case, the order management application P2 may be stored in the main memory 12.

FIG. 4 is a block diagram illustrating a main part circuit configuration of the POS terminal 4. The POS terminal 4 includes a processor 41, a main memory 42, an auxiliary storage device 43, a display device 44, an input device 45, a reading device 46, a printer 47, a communication interface 48, and a transmission line 49.

The processor 41, the main memory 42, and the auxiliary storage device 43 have the same functions as the functions of the processor 11, the main memory 12, and the auxiliary storage device 13. The processor 41, the main memory 42, and the auxiliary storage device 43 are connected by the transmission line 49 to configure a computer that performs information processing for realizing various functions of the POS terminal 4. However, the auxiliary storage device 43 stores a POS terminal application P3. The POS terminal application P3 is an application program for realizing the various functions of the POS terminal 4. Typically, the POS terminal 4 in which the POS terminal application P3 is stored in the auxiliary storage device 43 is transferred to the company or the like that operates the store. However, the POS terminal application P3 may be transferred to the company or the like that stores separately from hardware of the POS terminal 4. The transfer of the POS terminal application P3 can be realized by recording the POS terminal application P3 in a removable recording medium such as a magnetic disk, a magneto-optical disk, an optical disk, and a semiconductor memory or downloading the POS terminal application P3 via a network. In this case, the POS terminal application P3 is written in the auxiliary storage device 43 according to operation by an administrator of the POS terminal 4, a setting operator of the POS terminal 4, or the like. This is, for example, when the POS terminal application P3 is provided as a version-up application. The POS terminal application P3 may be stored in the main memory 42.

The display device 44 displays various screens for notifying various kinds of information to an operator. As the display device 44, a well-known device such as a liquid crystal display device can be applied. The input device 45 inputs various instructions by the operator. As the input device 45, well-known devices such as a touch sensor and a keyboard can be applied independently or in combination.

The reading device 46 reads data stored or displayed in a recording medium or data displayed by the display device. As the reading device 46, well-known devices such as a barcode scanner and a card reader can be applied independently or in combination. The printer 47 prints various images on paper. The printer 47 uses, for example, receipt paper as the paper. The printer 47 prints, for example, a receipt image to issue a receipt. The communication interface 48 and the transmission line 49 have the same functions as the functions of the communication interface 15 and the transmission line 16.

The operation of the POS system 100 configured as explained above is explained. Contents of various kinds of processing explained below are examples. A change of the order of a part of the processing, omission of a part of the processing, addition of another kind of processing, or the like is possible as appropriate.

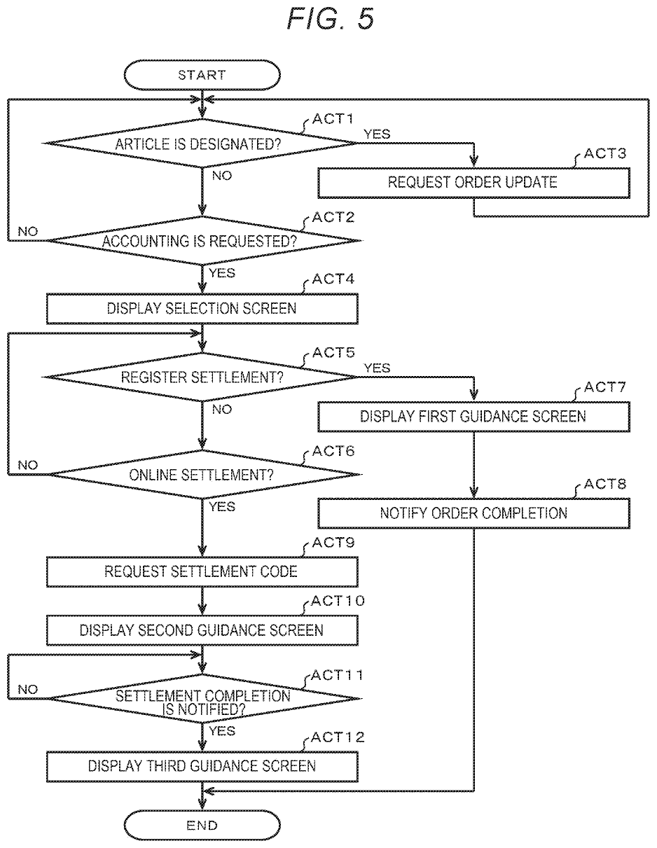

In the table terminal 1, the processor 11 executes, if an order by a customer should be accepted, guidance for the customer concerning the order and information processing for input of an instruction by the customer (hereinafter referred to as table terminal processing) according to the table terminal application P1. FIG. 5 is a flowchart of the table terminal processing.

In ACT 1, the processor 11 confirms whether an article to be ordered is designated. If operation for designating an article is not performed, the processor 11 determines NO and proceeds to ACT 2. In ACT 2, the processor 11 confirms whether accounting is requested. If operation for requesting accounting is not performed, the processor 11 determines NO and returns to ACT 1. In this way, in ACT 1 and ACT 2, the processor 11 waits for an article to be designated or accounting to be requested. During this period, the processor 11 presents articles that can be ordered and causes the touch panel 14 to display a graphical user interface (GUI) screen for accepting designation of an article to be ordered. The GUI screen includes GUI elements such as an accounting button for requesting accounting.

If the customer determines an article to be ordered, the customer operates the touch panel 14 to designate the article as an order target. If the touch panel 14 receives such a designation, the processor 11 determines YES in ACT 1 and proceeds to ACT 3. In ACT 3, the processor 11 requests the order management apparatus 2 to perform an order update. For example, the processor 11 transmits request data, which includes a terminal code for identifying the table terminal 1 and an article code for identifying a designated article together with a command representing a request for order update, from the communication interface 15 to the order management apparatus 2 via the communication network 5. In this way, the processor 11 executes information processing based on the table terminal application P1, whereby the computer including the processor 11 as the central part functions as an accepting section that accepts the order. In the order management apparatus 2, the communication interface 24 receives the request data transmitted to the order management apparatus 2 via the communication network 5 and notifies the processor 21 that the request data is received.

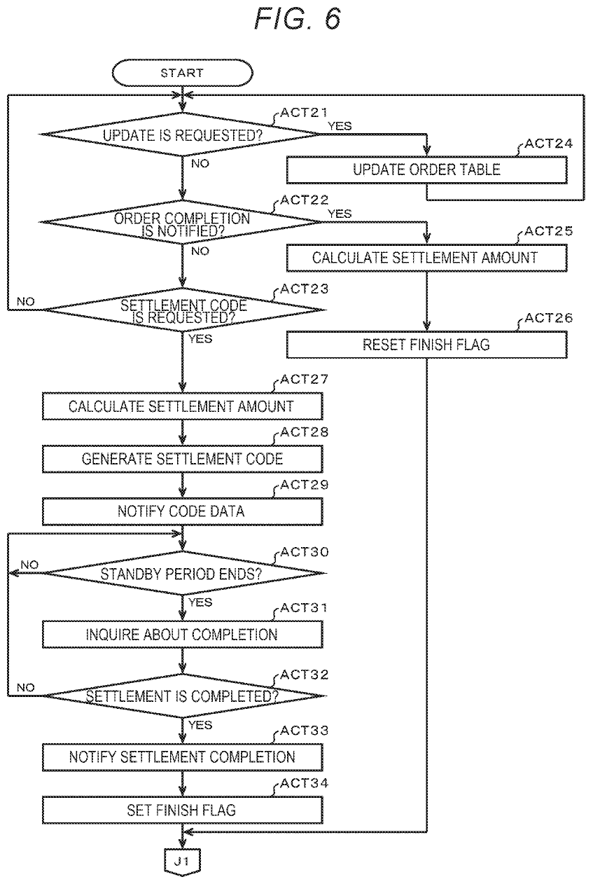

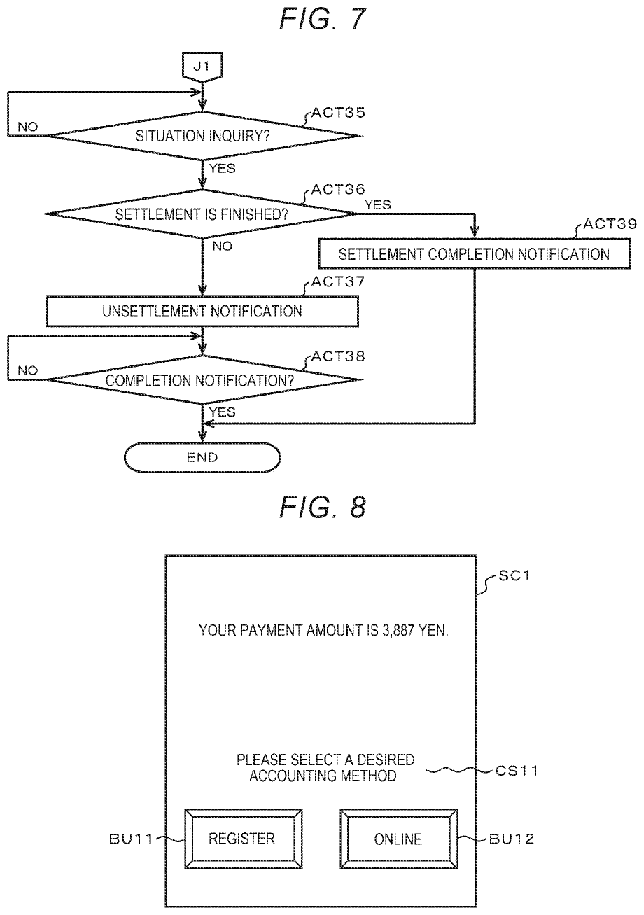

The processor 21 executes, according to the order management application P2, information processing for managing an order in the table terminal 1 (hereinafter referred to as management processing). The processor 21 executes the management processing in parallel targeting the respective plurality of table terminals 1. In the following explanation, the management processing targeting one table terminal 1 is explained. Therefore, if “table terminal 1” is simply described in the explanation of the management processing, the “table terminal 1” indicates the table terminal 1 set as a target of the management processing being explained. FIGS. 6 and 7 are flowcharts of the management processing.

In ACT 21, the processor 21 confirms whether an update request is received. If the update request is not received, the processor 21 determines NO and proceeds to ACT 22. In ACT 22, the processor 21 confirms whether an order completion notification is performed. If the order completion notification is not performed, the processor 21 determines NO and proceeds to ACT 23. In ACT 23, the processor 21 confirms whether a settlement code request is performed. If the settlement code request is not performed, the processor 21 determines NO and returns to ACT 21. In this way, in ACT 21 to ACT 23, the processor 21 waits for any one of the update request, the order completion notification, and the settlement code request to be performed.

If the request data for the request for the order update is received by the communication interface 24 and the request data is transmitted from the target table terminal 1, the processor 21 determines YES in ACT 21 and proceeds to ACT 24. That is, for example, if the request data received by the communication interface 24 includes a terminal code of the target table terminal 1, the processor 21 determines YES in ACT 21.

In ACT 24, the processor 21 updates an order table according to the request by the request data. The order table is table data representing a list of articles designated as order targets. The order table is associated with each of the plurality of table terminals 1. The order table is stored in the main memory 22 or the auxiliary storage device 23. Therefore, for example, the processor 21 updates the order table associated with the target table terminal 1 to include an article identified by an article code included in the request data. If the processor 21 finishes updating the order table, the processor 21 returns to the waiting state in ACT 21 to ACT 23. In this way, the order is managed in association with each of the plurality of table terminals 1. The processor 21 executes the information processing based on the order management application P2 in this way, whereby the computer including the processor 21 as the central part functions as an order managing section.

If the customer sets a plurality of articles as order targets, the customer repeats the operation for designating an article. The order table is sequentially updated as explained above according to the operation. If the customer desires to perform accounting, the customer touches the accounting button. If this operation is input by the touch panel 14, the processor 11 determines YES in ACT 2 in FIG. 5 and proceeds to ACT 4. In ACT 4, the processor 11 causes the touch panel 14 to display a selection screen. The selection screen is a GUI screen for causing the customer to select one of settlement in the POS terminal 4 (hereinafter referred to as register settlement) and settlement performed using the settlement site 400 (hereinafter referred to as online settlement).

FIG. 8 is a diagram illustrating a selection screen SC1. The selection screen SC1 is an example of a selection screen displayed when a price amount concerning all ordered articles is 3,887 yen.

For example, the processor 11 combines a character string “3,887”, which represents the price amount, with a basic form of a predetermined selection screen to generate the selection screen SC1. Therefore, the character string “3,887” is sometimes different on selection screens different from the selection screen SC1. For example, the processor 11 retains a history of order requests to the order management apparatus 2 in, for example, the main memory 12 and calculates the price amount based on the history. Alternatively, for example, the processor 11 inquires of the order management apparatus 2 and acquires the price amount. At this time, in the order management apparatus 2, the processor 21 calculates the price amount based on the order table and notifies the price amount to the table terminal 1.

The selection screen SC1 represents a character string CS11 and buttons BU11 and BU12 included in the basic form. Therefore, the same character string CS11 and buttons BU11 and BU12 are included in selection screens different from the selection screen SC1. The character string CS11 represents a character message for urging the customer to select an accounting method. The button BU11 is a GUI element such as an icon that the customer should operate if the customer selects the register settlement. The button BU12 is a GUI element such as an icon that the customer should operate if the customer selects the online settlement.

In ACT 5, the processor 11 confirms whether the register settlement is designated. If the register settlement is not designated, the processor 11 determines NO and proceeds to ACT 6. In ACT 6, the processor 11 confirms whether the online settlement is designated. If the online settlement is not designated, the processor 11 determines NO and returns to ACT 5. In this way, in ACT 5 and ACT 6, the processor 11 waits for the register settlement or the online settlement to be designated.

If the customer desires the register settlement, the customer touches the button BU11. If this operation is input by the touch panel 14, the processor 11 determines YES in ACT 5 and proceeds to ACT 7. In ACT 7, the processor 11 causes the touch panel 14 to display a first guidance screen. The first guidance screen is a screen for informing the customer of the register settlement.

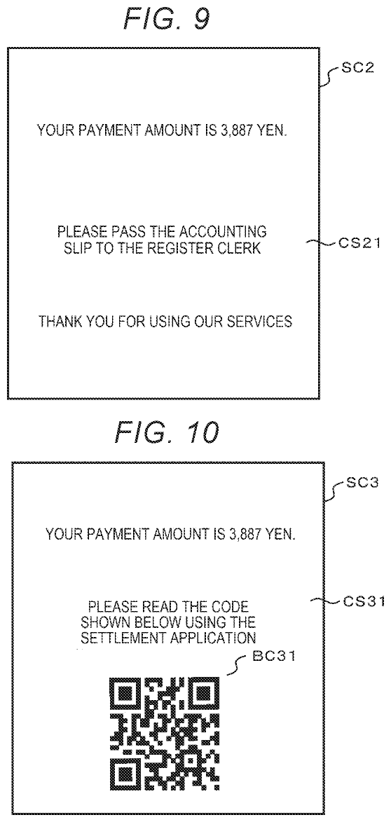

FIG. 9 is a diagram illustrating a first guidance screen SC2. The first guidance screen SC2 is an example of a first guidance screen displayed when a price amount concerning all ordered articles is 3,887 yen. That is, the first guidance screen SC2 is an example of a first guidance screen displayed if the customer touches the button BU11 on the selection screen SC1 illustrated in FIG. 8.

For example, the processor 11 combines a character string “3,887”, which represents the price amount, with a basic form of a predetermined first guidance screen to generate the first guidance screen SC2. Therefore, the character string “3,887” is sometimes different on first guidance screens different from the first guidance screen SC2.

The first guidance screen SC2 represents a character string CS21 included in the basic form. Therefore, the same character string CS21 is also included in first guidance screens different from the first guidance screen SC2. The character string CS21 represents a character message for informing the customer that, for accounting, the customer should pass an accounting slip to a register clerk. The accounting slip is passed from a store clerk to a customer, for example, when the customer entering the store is guided to a customer seat or when provision of all articles ordered by the customer is completed. The accounting slip may be printed by a printer included in the table terminal 1. A slip code for identifying the accounting slip is associated with the accounting slip. The slip code is also associated with a terminal code of the table terminal 1 used by the customer. As the accounting slip, a plate or the like on which a slip code is fixedly decided may be used.

In ACT 8, the processor 11 notifies completion of the order to the order management apparatus 2. For example, the processor 11 transmits notification data, which includes the terminal code for identifying the table terminal 1 together with a command representing the order completion notification, from the communication interface 15 to the order management apparatus 2 via the communication network 5. Accordingly, the processor 11 ends the table terminal processing.

In the order management apparatus 2, if the communication interface 24 receives the notification data, the processor 21 determines YES in ACT 22 in FIG. 6 in the management processing targeting the table terminal 1, which transmits the notification data, and proceeds to ACT 25. In ACT 25, the processor 21 calculates a settlement amount. For example, the processor 21 calculates a price amount concerning all articles included in the order table associated with the target table terminal 1 and sets the price amount as a settlement amount. A method of calculating the price amount conforms to, for example, rules decided for each store. That is, for example, the processor 21 calculates the price amount as a sum of unit prices of the respective articles included in the order table. Alternatively, for example, if predetermined conditions are satisfied, the processor 21 performs discount processing on the sum and calculates the price amount. The processor 21 may not calculate the settlement amount and the processor 41 may calculate the settlement amount in the POS terminal 4. In this case, the processor 21 requests, while notifying the order table, the POS terminal 4 to calculate the settlement amount. In the POS terminal 4, the processor 41 calculates, according to the request, the settlement amount, for example, in the same manner as explained above based on the notified order table. The processor 41 returns the calculated settlement amount to the order management apparatus 2 as a response to the request.

In ACT 26, the processor 21 brings a finish flag concerning the target table terminal 1 into a reset state. The finish flag is a flag indicating whether settlement is completed. In this embodiment, the reset state indicates that the settlement is not completed. The finish flag is, for example, data of one bit or a plurality of bits and is stored in the main memory 22 or the auxiliary storage device 23. If the management processing is executed in parallel concerning a plurality of table terminals 1, a plurality of finish flags concerning the respective plurality of table terminals 1 are stored in the main memory 22 or the auxiliary storage device 23.

On the other hand, if the customer desires the online settlement, the customer touches the button BU12 on the selection screen. If this operation is input by the touch panel 14, the processor 11 determines YES in ACT 6 in FIG. 5 and proceeds to ACT 9. In ACT 9, the processor 11 requests the order management apparatus 2 to transmit a settlement code. For example, the processor 11 transmits request data, which includes the terminal code for identifying the table terminal 1 together with a command representing the request for the settlement code, from the communication interface 15 to the order management apparatus 2 via the communication network 5.

If the communication interface 24 receives the request data, in the order management apparatus 2, the processor 21 determines YES in ACT 23 in FIG. 6 in the management processing targeting the table terminal 1, which transmits the request data, and proceeds to ACT 27. In ACT 27, the processor 21 calculates a settlement amount in the same manner as ACT 25. At this time as well, the calculation of the settlement amount may be performed in the POS terminal 4.

In ACT 28, the processor 21 generates a settlement code. For example, the processor 21 generates, as the settlement code, a code optically readably representing settlement data for causing the information terminal 200 to settle an order using the settlement site 400. In this embodiment, the settlement data includes a settlement amount, contracted company information, a table number, a slip code, and a uniform resource locator (URL). However, the settlement data may not include a part of information such as the URL or may include information different from the above such as a name of a customer. A form of the settlement code may be optional. However, a two-dimensional code such as QR code (registered trademark) is suitable. For example, the processor 21 represents, in the settlement code, the settlement amount calculated in ACT 27. For example, the processor 21 represents, in the settlement code, as the contracted company information, a company code for identifying, in the settlement site 400, the company or the like that operates the store. For example, the processor 21 represents, in the settlement code, as a table number, a number given to a table on which the table terminal 1 identified by the terminal code included in the request data is set. For example, the processor 21 represents, in the settlement code, a slip code associated with, at this point in time, the terminal code included in the request data. For example, the processor 21 represents, in the settlement code, a URL for accessing the settlement site 400 via the communication network 300.

In ACT 29, the processor 21 notifies code data representing the generated settlement code to the table terminal 1. For example, the processor 21 transmits notification data, which includes the code data together with a command representing the notification of the settlement code, from the communication interface 24 to the table terminal 1 via the communication network 5. If the notification data is transmitted via the communication network 5, in the table terminal 1, the communication interface 15 receives the notification data. In the POS terminal 4, the processor 41 may execute the generation and the notification of the settlement code. In this case, the processor 41 acquires the settlement amount, the contracted company information, the table number, the slip code, and the URL from the order management apparatus 2. However, at least one of the contracted company information and the URL may be saved in the main memory 22 or the auxiliary storage device 23 in advance. The processor 41 may read out the contracted company information or the URL. If the processor 41 calculates the settlement amount, the processor 41 does not acquire the settlement amount from the order management apparatus 2.

In the table terminal 1, if the processor 11 requests, in ACT 9 in FIG. 5, the order management apparatus 2 to transmit the settlement code, the processor 11 proceeds to ACT 10. In ACT 10, the processor 11 causes the touch panel 14 to display a second guidance screen. The second guidance screen is a screen for informing the customer of the online settlement.

FIG. 10 is a diagram illustrating a second guidance screen SC3. The second guidance screen SC3 is an example of a second guidance screen displayed when a price amount concerning all ordered articles is 3,887 yen. That is, the second guidance screen SC3 is an example of a second guidance screen displayed if the button BU12 on the selection screen SC1 illustrated in FIG. 8 is touched by the customer.

For example, the processor 11 combines a character string “3,887”, which represents the price amount, and a settlement code BC31 represented by the code data included in the notification data received by the communication interface 15 with a basic form of a predetermined second guidance screen to generate the second guidance screen SC3. Therefore, the character string “3,887” and the settlement code BC31 are sometimes different on a second guidance screen different from the second guidance screen SC3.

The second guidance screen SC3 represents a character string CS31 included in the basic form. Therefore, the character string CS31 is included in common in the second guidance screen different from the second guidance screen SC3. The character string CS31 represents a character message for informing the customer that the settlement code BC31 should be read by an application for the online settlement executed by the information terminal 200. The settlement code may be generated by the processor 11 in generating the second guidance screen in this way. In this case, in the order management apparatus 2, the processor 21 notifies the settlement amount, the contracted company information, the table number, the slip code, and the URL instead of notifying the code data representing the settlement code to the table terminal 1 in ACT 29. In the table terminal 1, the processor 11 generates a settlement code using the notified information. However, at least any one of the contracted company information, the URL, and the table number may be saved in the main memory 12 or the auxiliary storage device 13 in advance and may not be notified from the order management apparatus 2 to the table terminal 1. The slip code may be saved in the main memory 12 or the auxiliary storage device 13 before the second guidance screen is generated. The processor 21 may not notify the slip code in ACT 29.

In order to perform the online settlement, the customer causes the information terminal 200 carried by the customer to read the settlement code displayed on the second guidance screen. Then, the information terminal 200 acquires data represented by the settlement code. The information terminal 200 accesses the settlement site 400 according to the URL represented by the settlement code and settles the settlement amount represented by the settlement code. As processing for the settlement, existing processing for the online settlement can be directly applied. As a settlement medium used for the settlement at this time, for example, a credit card, an electronic money, a virtual currency, a prepaid card, and any other media can be applied as appropriate. If the settlement site 400 completes the settlement, the settlement site 400 notifies the information terminal 200 to that effect. In the processing for the settlement, the information terminal 200 notifies the settlement amount, the contracted company information, the table number, and the slip code represented by the settlement code to the settlement site 400. An application for the online settlement may be installed in the information terminal 200. The reading of the settlement code in the information terminal 200 may be executed as processing of the application.

As explained above, the information terminal 200 acquires data for performing settlement by reading the settlement code. That is, operation for generating the settlement code and readably displaying the settlement code in the information terminal 200 is equivalent to operation for causing the information terminal 200 to acquire the data for settlement. Therefore, the generation of the settlement code and the notification of the settlement code to the table terminal 1 by the processor 21 are a part of operation for causing the information terminal 200 to acquire the data for settlement and are a function of a notifying section. The processor 11 causing the touch panel 14 to display the notified settlement code is a part of the operation for causing the information terminal 200 to acquire the data for settlement and is a function of an executing section. That is, the processors 11 and 21 respectively execute the information processing according to the table terminal application P1 and the order management application P2, whereby a function of an operating section that performs the operation for causing the information terminal 200 to acquire the data for settlement is realized by cooperation of the processors 11 and 21.

In the order management apparatus 2, after notifying the code data in ACT 29 in FIG. 6, the processor 21 proceeds to ACT 30. In ACT 30, the processor 21 waits for a predetermined standby period to end. The standby period is set to, for example, a period until time at a fixed interval is reached. In this case, for example, if time clocked by a clocking function of the processor 21 reaches predetermined time at a fixed interval, the processor 21 determines YES and proceeds to ACT 31. The processor 21 may set, as the standby period, a period until a fixed time elapses after the processor 21 shifts to a waiting state in ACT 30. Start timing and end timing of the standby period and the length of the standby period may be decided as appropriate by a designer of the order management apparatus 2. The processor 21 may change the standby period according to an instruction by the administrator of the order management apparatus 2.

In ACT 31, the processor 21 inquires of the settlement site 400 about completion. For example, the processor 21 transmits inquiry data, which includes data for specifying a settlement case together with a command representing the completion inquiry, from the communication interface 24 to the settlement site 400 via the communication network 300. The data for specifying the settlement case is, for example, the contracted company information, the table number, and the slip code represented by the settlement code generated in ACT 28. However, the data for specifying the settlement case may be, for example, an identification code for identifying the settlement case. In this case, the processor 21 represents the identification code in the settlement code. The information terminal 200 notifies the identification code represented by the settlement code to the settlement site 400.

If the settlement site 400 completes the settlement, the settlement site 400 saves, as data concerning the completed settlement, the contracted company information, the table number, and the slip code notified from the information terminal 200 in the settlement. If the settlement site 400 receives the inquiry data transmitted via the communication network 300, the settlement site 400 confirms whether the contracted company information, the table number, and the slip code included in the inquiry data are saved as the data concerning the completed settlement to determine whether the inquired settlement is completed. The settlement site 400 transmits communication data representing a result of the determination to the order management apparatus 2 via the communication network 300 as a response to the completion inquiry. If the notification data is transmitted to the order management apparatus 2 via the communication network 300, the notification data is received by the communication interface 24.

In ACT 32, the processor 21 confirms whether the notification data received as explained above notifies the completion of the settlement. If the notification data notifies incompletion, the processor 21 determines NO and returns to the waiting state in ACT 30. In this way, if the settlement is not completed, the processor 21 repeats the completion inquiry at a fixed time interval. If the notification data received by the communication interface 24 represents the completion of the settlement, the processor 21 determines YES in ACT 32 and proceeds to ACT 33. The processor 21 executes the information processing based on the order management application P2 in this way, whereby the computer including the processor 21 as the central part functions as a determining section that determines the completion of the settlement.

In ACT 33, the processor 21 notifies the settlement completion to the table terminal 1. For example, the processor 21 transmits notification data, which includes a command representing the notification of the settlement completion, from the communication interface 24 to the table terminal 1 via the communication network 5. In ACT 34, the processor 21 brings the finish flag into a set state.

The processor 21 sets the state of the finish flag in ACT 26 or ACT 34 in this way to manage whether the settlement concerning each of the plurality of table terminals is completed. In other words, the processor 21 causes the auxiliary storage device 23 to store completion information or incompletion information of the settlement indicating whether the settlement concerning each of the plurality of table terminals 1 is completed. The processor 21 executes the information processing based on the order management application P2 in this way, whereby the computer including the processor 21 as the central part functions as a settlement managing section. If the notification data is transmitted to the table terminal 1 via the communication network 5, the communication interface 15 receives the notification data.

In the table terminal 1, the processor 11 proceeds to ACT 11 in a state in which the second guidance screen displayed on the touch panel 14 in ACT 10 in FIG. 5 is kept as it is. In ACT 11, the processor 11 waits for a settlement completion notification. If the notification data for the settlement completion notification is received by the communication interface 15 as explained above, the processor 11 determines YES and proceeds to ACT 12. In ACT 12, the processor 11 causes the touch panel 14 to display a third guidance screen. The third guidance screen is a screen for informing the customer that the completion of the online settlement is successfully confirmed and informing what the customer should perform after the completion of the online settlement.

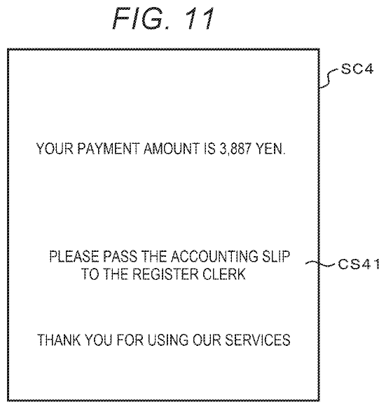

FIG. 11 is a diagram illustrating a third guidance screen SC4. The third guidance screen SC4 is an example of a third guidance screen displayed when the settlement amount is 3,887 yen. That is, the third guidance screen SC4 is an example of a third guidance screen displayed after the button BU12 on the selection screen SC1 illustrated in FIG. 8 is touched by the customer and the online settlement is performed.

For example, the processor 11 combines a character string “3,887”, which represents the settlement amount, with a basic form of a predetermined third guidance screen to generate the third guidance screen SC4. Therefore, the character string “3,887” is sometimes different on other third guidance screens different from the third guidance screen SC4. The third guidance screen SC4 represents a character string CS41 included in the basic form. Therefore, the same character string CS41 is included in third guidance screens different from the third guidance screen SC4. The character string CS41 represents a character message for informing the customer that the customer should pass an accounting slip to a register clerk when exiting the store.

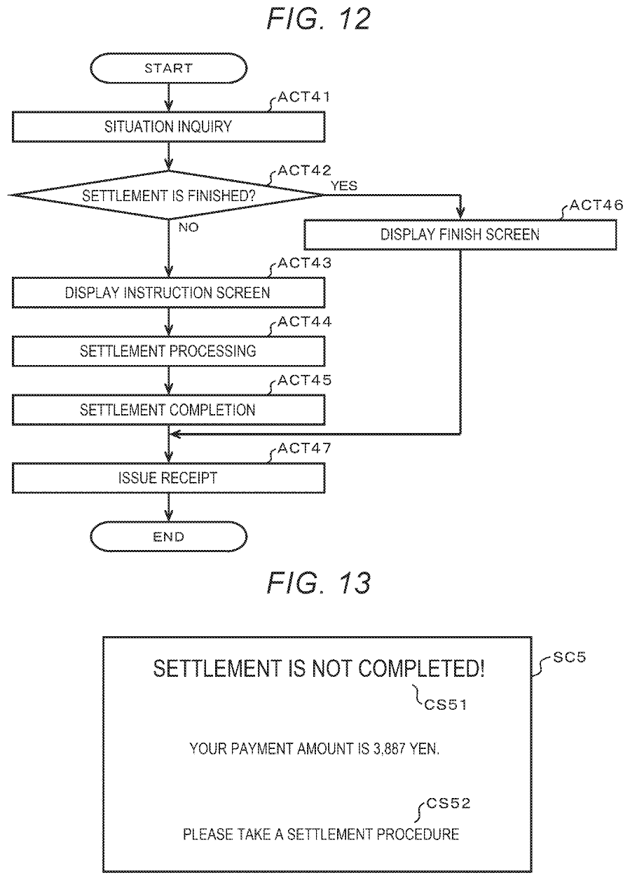

That is, in this embodiment, in both the cases of the register settlement and the online settlement, the customer carries an accounting slip, moves to the checkout counter or the like, and passes the accounting slip to a store clerk when existing the store. Therefore, the customer carries the accounting slip, moves to the checkout counter or the like, and passes the accounting slip to the store clerk according to guidance on the first guidance screen or the third guidance screen. The store clerk inputs a slip code displayed on the received accounting slip to the POS terminal 4. For example, the store clerk causes the reading device 46 of the POS terminal 4 to read a code optically readably representing data including the slip code displayed on the accounting slip. Alternatively, for example, the store clerk inputs the slip code displayed on the accounting slip using the input device 45. If these operations for inputting the slip code are performed, the reading device 46 or the input device 45 interrupts the processor 41. In response to the interrupt, the processor 41 executes information processing for checkout (hereinafter referred to as checkout processing) according to the POS terminal application P3. FIG. 12 is a flowchart of the checkout processing.

In ACT 41, the processor 41 inquires of the order management apparatus 2 about a settlement situation concerning an order in the table terminal 1 associated with the input slip code. For example, the processor 41 transmits inquiry data, which includes the slip code together with a command representing the situation inquiry, from the communication interface 48 to the order management apparatus 2 via the communication network 5. In the order management apparatus 2, the communication interface 24 receives the inquiry data.

In the order management apparatus 2, after setting the state of the finish flag in ACT 26 or ACT 34 in FIG. 6, the processor 21 proceeds to ACT 35 in FIG. 7. In ACT 35, the processor 21 waits for the situation inquiry from the POS terminal 4. If the inquiry data is received by the communication interface 24 as explained above and the table terminal 1 identified by a terminal code associated with the slip code included in the inquiry data is the table terminal 1 set as the target of the management processing, the processor 21 determines YES and proceeds to ACT 36.

In ACT 36, the processor 21 confirms whether the settlement for the order in the table terminal 1 is finished. For example, if the finish flag corresponding to the table terminal 1 is in the reset state, the processor 21 determines NO and proceeds to ACT 37. In ACT 37, the processor 21 transmits an unsettlement notification to the POS terminal 4. For example, the processor 21 transmits notification data, which includes a command representing the unsettlement notification, from the communication interface 24 to the POS terminal 4, which performs the situation inquiry, via the communication network 5. In the POS terminal 4, the communication interface 48 receives the notification data.

In the POS terminal 4, after performing the situation inquiry in ACT 41 in FIG. 12, the processor 41 proceeds to ACT 42. In ACT 42, the processor 41 confirms whether the settlement is finished. If the received notification data includes the command representing the unsettlement notification as explained above, the processor 41 determines NO and proceeds to ACT 43. In ACT 43, the processor 41 causes the display device 44 to display an instruction screen. The instruction screen is a screen for instructing the register clerk to take a procedure for settlement.

FIG. 13 is a diagram illustrating an instruction screen SC5. The instruction screen SC5 is an example of an instruction screen displayed when a settlement amount is 3,887 yen. That is, the instruction screen SC5 is an example of an instruction screen displayed when the button BU11 on the selection screen SC1 illustrated in FIG. 8 is touched by a customer.

For example, the processor 41 combines a character string “3,887”, which represents an amount that should be settled, with a basic form of a predetermined instruction screen to generate the instruction screen SC5. Therefore, the character string “3,887” is sometimes different on other instruction screens different from the instruction screen SC5. The instruction screen SC5 represents character strings CS51 and CS52 included in the basic form. Therefore, the same character strings CS51 and CS52 are included in instruction screens different from the instruction screen SC5. The character string CS51 represents a character message for informing the register clerk that settlement for an order concerning a read accounting slip is not completed. The character string CS52 represents a character message for guiding the register clerk to take a procedure for the settlement.

In ACT 44, the processor 41 executes settlement processing. As the settlement processing, the same processing as processing performed in an existing POS system for facing-type settlement based on a slip code can be applied. As a settlement medium used for the settlement at this time, for example, cash, a credit card, an electronic money, a virtual currency, a prepaid card, a coupon, and any other media can be applied as appropriate.

In ACT 45, the processor 41 transmits a settlement completion notification to the order management apparatus 2. For example, the processor 41 transmits notification data, which includes the slip code together with a command representing the settlement completion notification, from the communication interface 48 to the order management apparatus 2 via the communication network 5. In the order management apparatus 2, the communication interface 24 receives the notification data.

In the order management apparatus 2, after transmitting the unsettlement notification in ACT 37 in FIG. 7, the processor 21 proceeds to ACT 38. In ACT 38, the processor 21 waits for a settlement completion notification. If the notification data is received by the communication interface 24 as explained above and the table terminal 1 identified by a terminal code associated with the slip code included in the notification data is the table terminal 1 set as the target of the management processing, the processor 21 determines YES and ends the management processing.

On the other hand, for example, if the finish flag corresponding to the table terminal 1, which performs the situation inquiry, is in the set state, the processor 21 determines YES in ACT 36 and proceeds to ACT 39. In ACT 39, the processor 21 transmits a settlement completion notification to the POS terminal 4. For example, the processor 21 transmits notification data, which includes a command representing a settlement finish notification, from the communication interface 24 to the POS terminal 4, which performs the situation inquiry, via the communication network 5. In the POS terminal 4, the communication interface 48 receives the notification data.

If the notification data received as explained above includes the command representing the settlement finish notification, in the POS terminal 4, the processor 41 determines YES in ACT 42 and proceeds to ACT 46. In ACT 46, the processor 41 causes the display device 44 to display a finish screen. The finish screen is a screen for informing the register clerk that the settlement is completed.

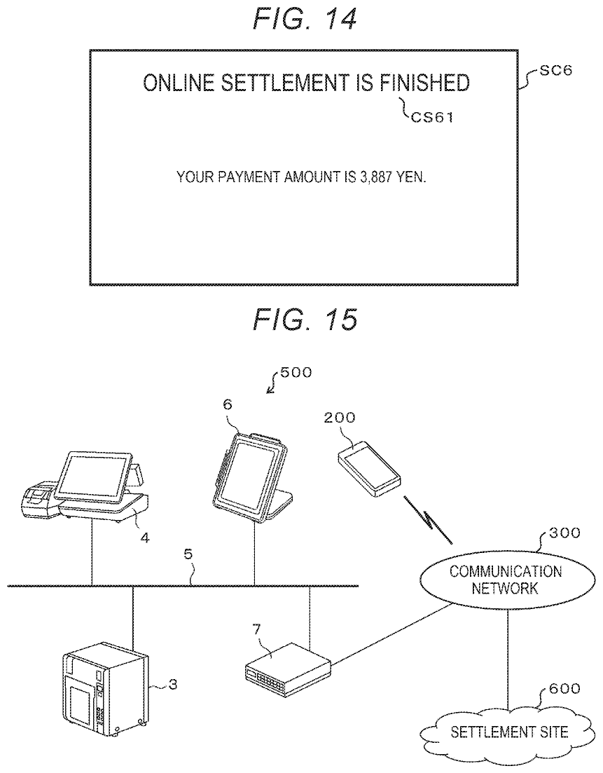

FIG. 14 is a diagram illustrating a finish screen SC6. The finish screen SC6 is an example of a finish screen displayed when a settlement amount is 3,887 yen. That is, the finish screen SC6 is an example of a finish screen displayed when the online settlement based on the second guidance screen SC3 illustrated in FIG. 10 is performed.

For example, the processor 41 combines a character string “3,887”, which represents an amount that should be settled, with a basic form of a predetermined finish screen to generate the finish screen SC6. Therefore, the character string “3,887” is sometimes a different character string on finish screens different from the finish screen SC6. The finish screen SC6 represents a character string CS61 included in the basic form. Therefore, the same character string CS61 is included in finish screens different from the finish screen SC6. The character string CS61 represents a character message for informing the register clerk that the settlement for the order concerning the accounting slip is completed.

If the processor 41 finishes ACT 45 or ACT 46, the processor 41 proceeds to ACT 47. In ACT 47, the processor 41 issues a receipt. For example, the processor 41 acquires, from the order management apparatus 2, an order table associated with the table terminal 1 associated with the slip code. For example, the processor 41 generates a list of order articles and a receipt image representing a settlement result or the like and causes the printer 47 to print the receipt image. Accordingly, the processor 41 ends the checkout processing. The register clerk passes the receipt discharged from the printer 47 to the customer. The customer receives the receipts and exits the store.

As explained above, with the POS system 100, the customer can finish the settlement in a customer seat without intervention of a store clerk. If the settlement for the order in the table terminal 1 associated with the input slip code is completed, the POS terminal 4 informs the store clerk to that effect by displaying the finish screen. That is, the store clerk can easily recognize whether each of a plurality of customers finishes settlement in a customer seat. Consequently, the store clerk does not need to perform work for settlement in the POS terminal 4 concerning the customer who finishes the settlement in the customer seat. The customer does not need to perform some operation for proving the completion of the settlement. The store clerk does not need to perform a confirming operation for, for example, questioning the customer. It is possible to allow the customer finishing the online settlement to smoothly exit the store.

With the POS system 100, if the settlement for the order in the table terminal 1 associated with the input slip code is not completed, the POS terminal 4 informs the store clerk to that effect by displaying the instruction screen. That is, concerning a customer not finishing the online settlement, the store clerk can easily recognize that the customer is a customer who should perform the settlement with the settlement processing in the POS terminal 4. Consequently, the store clerk is capable of smoothly performing settlement work in a facing type using the POS terminal 4.

With the POS system 100, irrespective of whether the customer selects the register settlement or the online settlement, the customer carries the accounting slip to the checkout counter or the like and the store clerk inputs the slip code of the accounting slip to the POS terminal 4. Therefore, operations of the customer and the store clerk concerning the checkout are simple. Burdens on the customer and the store clerk do not increase.

With the POS system 100, the online settlement is performed by the information terminal 200 and the settlement site 400. However, the order management apparatus 2 confirms, not via the information terminal 200, whether the settlement is completed. The POS terminal 4 confirms, not via the information terminal 200, whether the settlement is completed. Therefore, the information terminal 200 does not need to perform any operation for causing the order management apparatus 2 or the POS terminal 4 to confirm whether the settlement is completed.

The POS system 100 causes the information terminal 200 to acquire data such as the settlement amount, the contracted company information, the table number, the slip code, and the URL by causing the information terminal 200 to read the settlement code displayed on the table terminal 1. Therefore, it is unnecessary to use a medium and a communication section for exchange of the data. The table terminal 1 and the information terminal 200 do not need to include a device that performs reading and writing of a medium and a communication device.

### Second Embodiment

FIG. 15 is a diagram illustrating a schematic configuration of a POS system 500 according to a second embodiment. The same elements as the elements illustrated in FIG. 1 are denoted by the same reference numerals and signs. Detailed explanation of the elements is omitted.

The POS system 500 includes the slip printer 3, the POS terminal 4, the communication network 5, a table terminal 6, and an order management apparatus 7. That is, the POS system 500 includes the table terminal 6 and the order management apparatus 7 instead of the table terminal 1 and the order management apparatus 2 in the POS system 100. Only one table terminal 6 is illustrated. However, a plurality of table terminals 6 are included in the POS system 500. A plurality of order management apparatuses 7 may be included in the POS system 500. For online settlement, the POS system 500 uses a settlement site 600 instead of the settlement site 400. The settlement site 600 may be substantially the same as the settlement site 400. However, the settlement site 600 has a function of notifying an authentication code to the information terminal 200 if the settlement site 600 completes the settlement.

FIG. 16 is a block diagram illustrating a main part circuit configuration of the table terminal 6. The table terminal 6 includes the processor 11, the main memory 12, the auxiliary storage device 13, the touch panel 14, the communication interface 15, the transmission line 16, and a reading device 61. That is, hardware of the table terminal 6 has a configuration in which the reading device 61 is added to the hardware of the table terminal 1.

The reading device 61 reads a barcode displayed on a screen of the information terminal 200. As the reading device 61, for example, an existing device realized by combination of a camera and information processing by an application program for recognizing a barcode from an image photographed by the camera can be used. The table terminal 6 stores a table terminal application P11 in the auxiliary storage device 13 instead of the table terminal application P1.

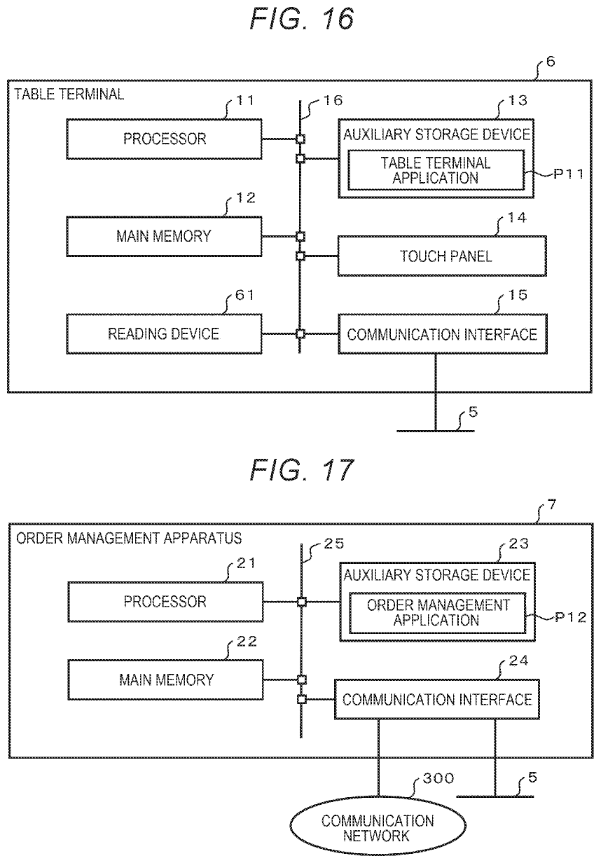

FIG. 17 is a block diagram illustrating a main part circuit configuration of the order management apparatus 7. The order management apparatus 7 includes the processor 21, the main memory 22, the auxiliary storage device 23, the communication interface 24, and the transmission line 25. That is, the order management apparatus 7 has the same hardware structure as the hardware structure of the order management apparatus 2. The order management apparatus 7 is different from the order management apparatus 2 in that the order management apparatus 7 stores an order management application P12 in the auxiliary storage device 23 instead of the order management application P2. The communication interface 24 may not be connected to the communication network 300. Alternatively, as the communication interface 24, a device not including a function of communication via the communication network 300 may be used.

The operation of the POS system 500 configured as explained above is explained. The operation of the POS system 500 is different from the operation of the POS system 100 in information processing for determining completion of the online settlement in the order management apparatus 7. Therefore, the operation different from the operation of the POS system 100 is mainly explained below.

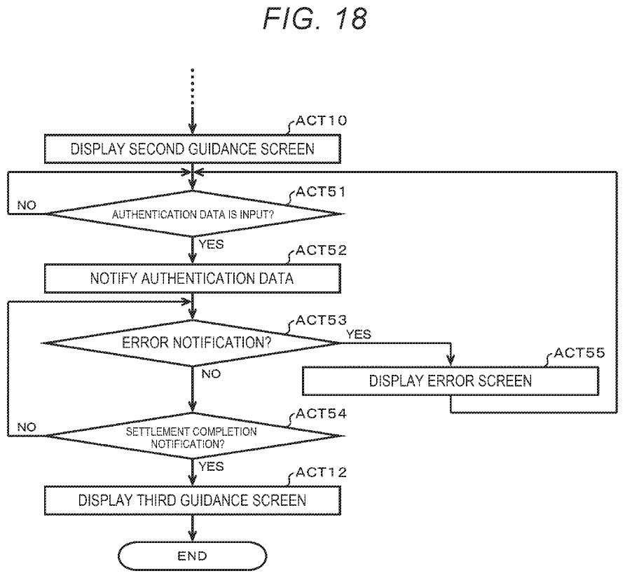

FIG. 18 is a flowchart of table terminal processing by the processor 11 of the table terminal 6. The processor 11 executes the table terminal processing according to the table terminal application P11. Among the kinds of processing of the table terminal processing conforming to the table terminal application P11, the same kinds of processing as the kinds of processing in the table terminal processing conforming to the table terminal application P1 are denoted by the same reference signs as the reference signs illustrated in FIG. 5. Illustration of a part of the kinds of processing is omitted in FIG. 18.

The processor 11 performs ACT 1 to ACT 10 as in the first embodiment. That is, in the second embodiment, as in the first embodiment, if a customer desires the online settlement, the customer accesses the settlement site 600 using the information terminal 200 and performs settlement. The settlement site 600 performs processing for settlement in the same manner as the settlement site 400. However, the settlement site 600 generates authentication data if the settlement site 600 completes the settlement. For example, among data obtained from the information terminal 200 for the settlement, the settlement site 600 sets, as original data, a predetermined part or all of the data represented by a settlement code as well. The settlement site 600 sets, as authentication data, a value obtained by processing the original data with a predetermined algorithm. The data used as the original data and the algorithm are optionally determined, for example, between an operator or the like of the settlement site 600 and an administrator or the like of the POS system 500. However, the data used as the original data and the algorithm only have to be known by the settlement site 600 and the POS system 500 or may be decided by anybody. The settlement site 600 transmits screen data representing a completion screen including a code optically readably representing the authentication data (hereinafter referred to as authentication code) to the information terminal 200. Consequently, the settlement site 600 notifies the authentication data to the information terminal 200. If the information terminal 200 receives the screen data, the information terminal 200 displays the completion screen according to the screen data. An authentication code BC71 is a two-dimensional code. However, the authentication code BC71 may be displayed on the completion screen in another form such as a character string corresponding to the authentication data.

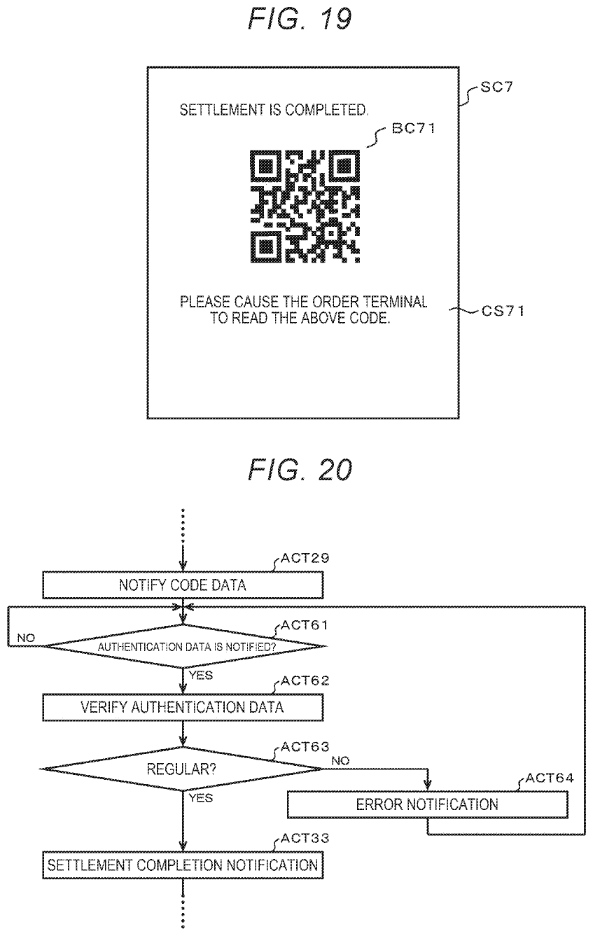

FIG. 19 is a diagram illustrating a completion screen SC7. The completion screen SC7 includes an authentication code BC71 and a character string CS71. The authentication code BC71 represents the authentication data explained above. The character string CS71 represents a character message for guiding the customer to cause the table terminal 6 to read the authentication code BC71. Therefore, the authentication code BC71 is different on completion screens different from the completion screen SC7.

If the completion screen is displayed on the information terminal 200, the customer causes the reading device 61 of the table terminal 6 to read the authentication code included in the completion screen. Therefore, the reading device 61 is an example of an acquiring section that acquires the authentication data.

In the table terminal 6, the processor 11 proceeds from ACT 10 to ACT 51. In ACT 51, the processor 11 waits for authentication data to be input. If an authentication code is read by the reading device 61, the processor 11 determines YES and proceeds to ACT 52. If a character string is used as the authentication code instead of the authentication code BC71, which is a two-dimensional code, in ACT 51, the processor 11 waits for the character string to be input. If the character string is input, the processor 11 proceeds to ACT 52.

In ACT 52, the processor 11 notifies authentication data represented by the authentication code to the order management apparatus 7. For example, the processor 11 transmits notification data, which includes the authentication data extracted from the authentication code by the reading device 61 together with a command representing notification of the authentication data, from the communication interface 15 to the order management apparatus 7 via the communication network 5.

FIG. 20 is a flowchart of management processing by the processor 21 of the order management apparatus 7. The processor 11 executes the management processing according to the order management application P12. Among the kinds of processing of the management processing conforming to the order management application P12, the same kinds of processing as the kinds of processing in the management processing conforming to the order management application P2 are denoted by the same reference signs as the reference signs illustrated in FIG. 6. Illustration of a part of the kinds of processing is omitted in FIG. 20.

The processor 21 performs ACT 21 to ACT 29 as in the first embodiment. The processor 21 proceeds from ACT 29 to ACT 61. In ACT 61, the processor 21 waits for authentication data to be notified. If the communication interface 24 receives the communication data transmitted from the table terminal 6 to the order management apparatus 7 via the communication network 5, the processor 21 determines YES and proceeds to ACT 62.

In ACT 62, the processor 21 authenticates the authentication data included in the notification data. For example, the processor 21 generates verification data by processing, according to the same algorithm as the algorithm used by the settlement side 600, among data represented by the settlement code, data that the settlement site 600 sets as original data for generating the authentication data. For example, the processor 21 confirms whether the verification data coincides with the authentication data.

In ACT 63, the processor 21 confirms, based on a result of the verification, whether the authentication code notified from the table terminal 6 is a regular authentication code. For example, if the verification data does not coincide with the authentication data, the processor 21 determines NO and proceeds to ACT 64. In ACT 64, the processor 21 transmits an error notification to the table terminal 6. For example, the processor 21 transmits notification data, which includes a command representing the error notification, from the communication interface 24 to the table terminal 6 via the communication network 5. Thereafter, the processor 21 returns to the waiting state in ACT 61.

On the other hand, for example, if the verification data coincides with the authentication data, the processor 21 determines YES in ACT 63 and proceeds to ACT 33. That is, if the processor 21 determines YES in ACT 63, the processor 21 performs the settlement completion notification as in the first embodiment. Thereafter, the processor 21 performs the processing in ACT 34 and subsequent acts in FIG. 6 as in the first embodiment. The notification data for the error notification or the settlement completion notification is transmitted from the order management apparatus 7 to the table terminal 6 via the communication network 5 as explained above. Then, the communication interface 15 receives the notification data.

In the table terminal 6, if the processor 11 ends ACT 52, the processor 11 proceeds to ACT 53. In ACT 53, the processor 11 confirms whether an error notification is performed. If the error notification is not performed, the processor 11 determines NO and proceeds to ACT 54. In ACT 54, the processor 11 confirms whether a settlement completion notification is performed. If the settlement completion notification is not performed, the processor 11 determines NO and returns to ACT 53. In this way, in ACT 53 and ACT 54, the processor 11 waits for the error notification or the settlement completion notification to be performed. If the notification data for the error notification is received by the communication interface 15 as explained above, the processor 11 determines YES in ACT 53 and proceeds to ACT 55.

In ACT 55, the processor 11 displays an error screen. For example, the processor 11 causes the touch panel 14 to display a predetermined error screen. The error screen is a screen for notifying the customer that an authentication code read by the table terminal 6 is not a regular authentication code. The processor 11 returns to the waiting state in ACT 51.

If the notification data for the settlement completion notification is received by the communication interface 15 as explained above, the processor 11 determines YES in ACT 54 and proceeds to ACT 12. The processor 11 executes ACT 12 as in the first embodiment.

As explained above, with the POS system 500, as in the POS system 100, the customer can finish settlement in a customer seat without intervention of a store clerk. If settlement for an order in the table terminal 6 associated with an input slip code is completed, the POS terminal 4 informs the store clerk to that effect by displaying a finish screen. That is, the store clerk can easily recognize whether each of a plurality of customers finishes settlement in a customer seat. Consequently, the store clerk does not need to perform work for settlement in the POS terminal 4. The customer does not need to perform some operation for proving the completion of the settlement. The store clerk does not need to perform a confirming operation for, for example, questioning the customer. It is possible to allow the customer finishing the online settlement to smoothly exit the store.

With the POS system 500, although labor of the customer increases compared with the POS system 100, it is unnecessary to repeat, between the order management apparatus 7 and the settlement site 600, an inquiry and a response for confirmation of a settlement result. Consequently, compared with the POS system 100, it is possible to reduce loads of information processing of the order management apparatus 7 and the settlement site 600 and a traffic amount in the communication network 300.

Various modified implementations explained below of the embodiment are possible. The processor 21 of the order management apparatus 2 may execute the information processing for the completion inquiry as separate processing in parallel to the management processing. In this case, the processor 21 may collectively perform inquiries concerning a plurality of table terminals 1, finish flags of which are in the reset state.

The settlement site 400 may be configured to be accessible to the order management apparatus 2.

The settlement site 400 may notify settlement completion to the order management apparatus 2 without an inquiry from the order management apparatus 2.

A method of enabling a store clerk to recognize a settlement situation may be any method such as a method of causing an information terminal for the store clerk to display a list of settlement situations of the table terminals 1 and 6.

Wireless communication, infrared communication, or the like may be used for exchange of data between the table terminal 1 or the table terminal 6 and the information terminal 200.

The settlement data may be transmitted from the order management apparatus 2 or 7 to the information terminal 200 via the communication network 300. In this case, for example, a code optically readably representing data for the information terminal 200 to access the order management apparatus 2 or 7 via the communication network 300 is displayed on the second guidance screen instead of the settlement code. The order management apparatus 2 or 7 transmits the settlement data to the information terminal 200 via the communication network 300 in response to the access from the information terminal 200 based on the data for the access.

The order management apparatus 2 or 7 may include a plurality of processors and perform, with the plurality of processors, distributed processing of the management processing concerning the respective plurality of table terminals 1. Alternatively, a plurality of order management apparatuses 2 or 7 may perform distributed processing of the management processing concerning the respective plurality of table terminals 1.

The table terminal 1 may be configured to be capable of accessing the settlement site 400 via the communication network 300. The table terminal 1 may inquire of the settlement site 400 to thereby determine whether settlement is completed. The table terminal 1 may notify a result of the determination to the order management apparatus 2.

The table terminal 6 may perform the verification of the authentication data in ACT 62 in FIG. 20. In this case, the processor 11 notifies a result of the verification to the order management apparatus 7. The processor 21 performs the confirmation in ACT 63 based on the notified verification result. The table terminal 6 may perform the verification of the verification data in ACT 62 and the confirmation in ACT 63. That is, for example, the processor 11 executes ACT 63 in FIG. 20 instead of ACT 52 in FIG. 18 and executes ACT 63 in FIG. 20 instead of ACT 53 and ACT 54 in FIG. 18. If the processor 11 determines NO in ACT 63, the processor 11 proceeds to ACT 55. If the processor 11 determines YES in ACT 63, the processor 11 proceeds to ACT 12. If the processor 11 determines YES, the processor 11 notifies the order management apparatus 2 or 7 that the settlement is completed.

The table terminal 6 may generate verification data. The order management apparatus 7 may collate the authentication data and the verification data.

The verification of the authentication data only has to be able to confirm that the notified authentication data is a code generated by the settlement site 600. Another method may be used for the verification of the authentication data. For example, two algorithms in which two values having a predetermined difference are respectively obtained by processing the same original data may be respectively used for the generation of the authentication data in the settlement site 600 and the generation of the verification data in the order management apparatus 7. In this case, in the order management apparatus 7, in ACT 62, the processor 21 confirms whether the verification data has the difference from the authentication data.

The order terminal may be realized as a terminal of a type different from the tables 1 and 6 such as a type attached to a wall of a single room or a mobile terminal type.

The embodiment can also be applied to an order system for order management of a service other than provision of foods and beverages. The embodiment can also be realized as an order system not including a POS function.

A part or all of the functions realized by the processors through the information processing can also be realized by hardware that executes information processing not based on a program such as a logic circuit. Each of the functions can also be realized by combining software control with the hardware such as the logic circuit.

The several embodiments are explained above. However, the embodiments are presented as examples and are not intended to limit the scope of the invention. These new embodiments can be implemented in other various forms. Various omissions, substitutions, and changes can be made without departing from the spirit of the invention. These embodiments and modifications of the embodiments are included in the scope and the gist of the invention and included in the inventions described in claims and the scope of equivalents of the inventions.

What is claimed is:

1. An order system including a plurality of order terminals and an order management apparatus, the order system comprising:
a plurality of accepting sections, each accepting section provided in one of the order terminals and configured to accept an order, the plurality of accepting sections including a first accepting section provided in a first order terminal of the plurality of order terminals;
an order managing section provided in the order management apparatus and configured to manage the order accepted by the first accepting section in association with the first order terminal;
an operating section provided in at least one of the first order terminal and the order management apparatus and configured to cause an information terminal carried by a customer to acquire settlement data for settling, with a network settlement service, the order managed by the order managing section;
a determining section provided in the first order terminal or the order management apparatus and configured to determine completion of the settlement by the network settlement service based on the settlement data; and
a settlement managing section provided in the order management apparatus and configured to manage, based on a result of the determination in the determining section, whether settlement concerning each of the plurality of order terminals is completed.

2. The order system of claim 1, wherein the determining section determines the completion of the settlement based on a notification from (a) a settlement apparatus that provides the network settlement service to (b) the order management apparatus.

3. The order system of claim 1, further comprising an acquiring section provided in the first order terminal and configured to acquire, from the information terminal and after the completion of the settlement, authentication data generated according to a predetermined generation rule and based on the settlement data,
wherein, if the authentication data acquired by the acquiring section coincides with verification data generated according to the predetermined generation rule and based on the settlement data acquired by the information terminal, the determining section determines that the settlement based on the settlement data is completed.

4. The order system of claim 3, wherein the information terminal is configured to display an authentication code to be optically read by the first order terminal, the authentication code containing the authentication data.

5. The order system of claim 4, wherein the verification data is generated by the order management apparatus according to the predetermined generation rule and based on the settlement data acquired by the information terminal.

6. The order system of claim 1, wherein the operating section includes:
a notifying section provided in the order management apparatus and configured to notify the first order terminal of the settlement data for settling, with the network settlement service, the order managed by the order managing section in association with the first order terminal; and
an executing section provided in the first order terminal and configured to execute the operation for causing the information terminal carried by the customer to acquire the settlement data notified by the notifying section.

7. The order system of claim 1, wherein the operating section is configured to display a settlement code to be optically read by the information terminal, the settlement code containing the settlement data.

8. The order system of claim 7, wherein the settlement data includes a settlement amount, contracted company information identifying a store where the order was received, and information identifying the first order terminal.

9. The order system of claim 8, wherein the settlement code is a two-dimensional code, and wherein the settlement data further includes instructions for the information terminal to access the network settlement service.

10. The order system of claim 1, further comprising a checkout section provided in a point of sale (POS) terminal of the order system, wherein, in response to receiving a settlement completion notification indicating that settlement concerning the first order terminal is completed, the checkout section is configured to provide a receipt for the order received by the first order terminal.

11. The order system of claim 10, wherein the POS terminal includes a printer that prints the receipt.

12. The order system of claim 10, wherein the checkout section is configured to request a settlement status of the order received by the first order terminal in response to receiving a slip code corresponding to the first order terminal.

13. The order system of claim 12, wherein the checkout section is configured to optically read a code representing the slip code.

14. An order management apparatus configuring an order system together with a plurality of order terminals, the order management apparatus comprising:
an order managing section configured to manage orders accepted by each of the plurality of order terminals in association with the order terminal that accepts the order, the plurality of order terminals including a first order terminal;
a notifying section configured to notify the first order terminal of settlement data for settling, with a network settlement service, an order managed by the order managing section in association with the first order terminal;
a determining section configured to determine completion of the settlement by the network settlement service based on the settlement data; and
a settlement managing section configured to manage, based on a result of the determination in the determining section, whether settlement concerning each of the plurality of order terminals is completed.

15. An information processing method for an order management apparatus configuring an order system together with a plurality of order terminals, the information processing method comprising:
managing an order accepted by each of the plurality of order terminals in association with the order terminal that accepts the order;
in response to an indication that a first customer associated with a first order terminal of the plurality of order terminals has chosen to settle online, providing, to the first order terminal, settlement data for settling, with a network settlement service, a first order associated with the first order terminal;
determining completion of the settlement of the first order by the network settlement service based on the settlement data; and
managing, based on a result of the determination, whether settlement concerning each of the plurality of order terminals is completed.

16. The information processing method of claim 15, further comprising in response to an indication that a second customer associated with a second order terminal of the plurality of order terminals has chosen to settle at a POS terminal, providing, to the second order terminal, a settlement amount for a second order associated with the second order terminal.

17. The information processing method of claim 16, further comprising:
determining that a settlement of the second order is not complete; and
providing a command to the POS terminal indicating that the POS terminal should instruct a clerk to request settlement of the second order.

18. The information processing method of claim 17, further comprising:
receiving a settlement completion notification from the POS terminal indicating that the settlement of the second order is complete; and
managing, based on the result of the determination and the settlement completion notification, whether settlement concerning each of the plurality of order terminals is completed.

19. The information processing method of claim 15, further comprising commanding the first order terminal to display a settlement code to be optically read by an information terminal, the settlement code containing the settlement data.

20. The information processing method of claim 15, wherein the settlement data includes a settlement amount associated with the first order, contracted company information identifying a store where the first order was received, and information identifying the first order terminal.
